(19) United States
(12) Patent Application Publication
(10) Pub. No.: US 2024/0151286 A1
(43) Pub. Date: May 9, 2024

(54) DEVICE FOR SENSING ATMOSPHERE TEMPERATURE IN VEHICLE BRAKE

(71) Applicants: Chang Hee YOO, Daegu (KR); Jung Gyu HWANG, Daegu (KR); Jin Su JANG, Daegu (KR); Uk Jin JEONG, Daegu (KR)

(72) Inventors: Chang Hee YOO, Daegu (KR); Jung Gyu HWANG, Daegu (KR); Jin Su JANG, Daegu (KR); Uk Jin JEONG, Daegu (KR)

(21) Appl. No.: 18/071,966

(22) Filed: Nov. 30, 2022

(30) Foreign Application Priority Data
Nov. 3, 2022 (KR) 10-2022-0145083

(51) Int. Cl. F16D 66/00; B60Q 9/00; B60T 17/22; G01K 1/143; G01K 7/16

(52) U.S. Cl. CPC F16D 66/00; B60Q 9/00; B60T 17/22; G01K 1/143; G01K 7/16; F16D 2066/001; F16D 2066/006

(57) ABSTRACT

Disclosed is a device for sensing atmosphere temperature in a vehicle brake, the device including a space formed in a brake lining, the space being open toward a drum, a through-hole formed through a brake shoe, a case fitted in the through-hole, the case being fixed to the through-hole by a plurality of fixing means, an insertion recess formed in the case, the insertion recess being formed so as to be open to the rear, an aeration hole formed in a front end of the case, the aeration hole being configured to allow the space and the insertion recess to be connected to each other such that aeration is performed therebetween, a temperature sensor fitted in the insertion recess, the temperature sensor being configured to measure frictional braking temperature transferred to the space, and a fixing member configured to fix the temperature sensor.

### BACKGROUND OF THE INVENTION

### Field of the Invention

The present invention relates to a device for sensing atmosphere temperature in a vehicle brake, and more particularly to a device for sensing atmosphere temperature in a vehicle brake, the device being configured such that a space connected to a frictional braking surface in such a manner that aeration is performed therebetween is provided in a brake lining of the vehicle brake, and a temperature sensor is installed in the space to measure braking frictional heat (frictional braking heat) generated during braking in a non-contact manner, whereby it is possible to rapidly and accurately determine atmosphere temperature in a brake system, and therefore it is possible to prevent overheating of the brake, fire outbreak of the brake, and shortening in lifespan of the brake while preventing occurrence of a safety-related accident of a vehicle.

### DESCRIPTION OF THE RELATED ART

In general, when a heavy vehicle, such as a medium- or large-sized bus or a truck, travels on a downhill, a mountain road, or a snowy road, braking time is increased while braking is frequently performed. As a result, braking frictional heat is accumulated in a drum and a shoe or in a disc and a pad, and the drum and the shoe or the disc and the pad are hardened, whereby a fade phenomenon occurs, and therefore a braking distance is lengthened, and fire breaks out due to overheating of a brake system. In particular, a fire outbreak danger of a drum brake is higher than a fire outbreak danger of a disc brake, since cooling efficiency of the drum brake is lower than cooling efficiency of the disc brake.

For the above reason, a temperature sensor is installed at the brake system, and when heat having a temperature higher than a predetermined temperature is generated, a driver is informed of overheating, whereby it is possible to prevent occurrence of various accidents. However, a temperature sensor installed at a conventional brake system is not capable of directly measure the temperature of a frictional braking surface or a frictional braking portion from which high-temperature braking frictional heat is generated during rotation. The temperature sensor is configured to measure (sense) the temperature of a brake pad, the temperature of a brake shoe, or the temperature of a rivet, and therefore it is possible for the temperature sensor to accurately measure surface temperature transmitted (conducted) to these brake parts or the temperature of the portion at which the temperature sensor is installed. However, the temperature sensor is not capable of accurately measuring atmosphere temperature in the brake system, i.e. the temperature of the frictional braking surface or the frictional braking portion, and therefore it is difficult to predict the overall status of the brake system.

In addition, when the temperature sensor is installed at the brake lining, the temperature sensor is also worn and/or damaged if the brake lining is worn, whereby it is not possible to reuse the temperature sensor. Furthermore, temperature measurement may be impossible or an error may occur in temperature measurement. Moreover, characteristics of measured temperature signals are non-linear, whereby reliability in temperature measurement is low.

### PRIOR ART DOCUMENTS

### Patent Documents

(Patent Document 1) Korean Registered Utility Model Publication No. 20-1994-0003266 (entitled DEVICE FOR MEASURING TEMPERATURE AND WEAR OF BRAKE BLOCK and published on May 19, 1994)
(Patent Document 2) Korean Patent Application Publication No. 10-2017-0077613 (entitled METHOD OF ESTIMATING TEMPERATURE OF VEHICLE BRAKE DISC and published on Jul. 6, 2017)
(Patent Document 3) Korean Patent Application Publication No. 10-2015-0134062 (entitled METHOD AND SYSTEM FOR ESTIMATING TEMPERATURE OF BRAKE DISC and published on Dec. 1, 2015)

### SUMMARY OF THE INVENTION

The present invention has been made in view of the above problems, and it is an object of the present invention to provide a device for sensing atmosphere temperature in a vehicle brake, the device being configured such that a space connected to a frictional braking surface in such a manner that aeration is performed therebetween is provided in a lining of a main brake of a vehicle, and a temperature sensor is installed in the space to measure braking frictional heat generated during braking in a non-contact manner, whereby it is possible to rapidly and accurately determine atmosphere temperature in a brake system, and therefore it is possible to prevent overheating of the brake, fire outbreak of the brake, and shortening in lifespan of the brake while preventing occurrence of a safety-related accident of the vehicle.

It is another object of the present invention to provide a device for sensing atmosphere temperature in a vehicle brake, the device configured such that atmosphere temperature in a brake system is measured using a temperature sensor, and the temperature sensor is cooperatively connected to a temperature monitoring device, a display device, and a warning device, and visual and aural warning is provided to a driver for each specific temperature step.

In accordance with the present invention, the above and other objects can be accomplished by the provision of a device for sensing atmosphere temperature in a vehicle brake, the device including a brake installed at a vehicle, a space formed in a brake lining, the space being open toward a drum, the space having a predetermined inner diameter, a through-hole formed through a brake shoe, the through-hole having a predetermined inner diameter, a case fitted in the through-hole, the case being fixed to the through-hole by a plurality of fixing means, an insertion recess formed in the case, the insertion recess being formed so as to be open to the rear, an aeration hole formed in a front end of the case, the aeration hole being configured to allow the space and the insertion recess to be connected to each other such that aeration is performed therebetween, the aeration hole having a predetermined inner diameter, a temperature sensor fitted in the insertion recess, the temperature sensor being configured to measure frictional braking temperature transferred to the space, and a fixing member configured to fix the temperature sensor.

The fixing means may include a front-end concave recess and a rear-end concave recess formed along an outer circumferential surface of the case in front and rear ends of the case and a front-end snap ring and a rear-end snap ring coupled to the front-end concave recess and the rear-end concave recess, respectively, the front-end snap ring and the rear-end snap ring being supported by the brake shoe.

The shape of the space may be a circle, a polygon, such as a quadrangle, a pentagon, a hexagon, or an octagon, an oval, or a combination thereof.

The inner diameter of the space may be 1.2 to 3 times the inner diameter of the through-hole.

The temperature sensor may be installed in the space so as to have a height less than the wear limit of the brake lining.

The temperature sensor may be may be a thermistor type temperature sensor or a resistance temperature detector (RTD) type temperature sensor.

The device may further include a voltage conversion unit connected to the temperature sensor, wherein the voltage conversion unit may include a temperature sensor resistor having both ends connected to the temperature sensor and a distribution resistor connected to the other end of the temperature sensor resistor, the distribution resistor being connected to a power supply.

The device may further include a temperature monitoring device connected to the voltage conversion unit and a display device and a warning device connected to the temperature monitoring device.

The temperature monitoring device may configure a temperature map for each of first, second, and third steps such that a display lamp is lit or blinked and a warning sound is output.

An inclined surface having a predetermined angle may be formed at the front end of the case so as to be inclined toward the front end thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view illustrating a case having a temperature sensor mounted therein in the present invention;

FIG. 2 is a partial sectional view illustrating the case having the temperature sensor mounted therein in the present invention;

FIG. 3 is a view illustrating the state in which the case having the temperature sensor mounted therein is installed in a space in the present invention;

FIG. 4 is a sectional view illustrating a non-braking state in the present invention;

FIG. 5 is a sectional view illustrating a braking state in the present invention;

FIG. 6 is a view illustrating configuration of a circuit of a voltage conversion unit of the present invention;

FIG. 7 is a view illustrating a warning map shown as an example of the present invention; and

FIG. 8 is a graph showing temperature characteristics of a surface temperature sensor and the temperature sensor of the present invention for comparison therebetween.

### DETAILED DESCRIPTION OF THE INVENTION

Hereinafter, preferred embodiments of the present invention will be described in detail with reference to the accompanying drawings. In describing the embodiments of the present invention, the same elements in the drawings are denoted by the same reference numerals if possible, and a detailed description of related known configurations and functions will be omitted such that the subject matter of the present invention is not obscured. In addition, the details shown in the accompanying drawings are schematized in order to easily describe the embodiments of the present invention and may be different from actually implemented shapes.

In the present invention, a drum brake for vehicles will be described by way of example; however, it is obvious that the present invention is applicable to a disc brake.

The present invention may be configured such that a temperature sensor is installed at a brake drum or a brake disc in order to directly measure frictional heat generated during braking. Since the brake drum or the brake disc is configured to be rotated together with a wheel, however, the present invention is configured such that a space connected to a braking frictional surface in such a manner that aeration is performed therebetween is formed in a brake lining, which is not rotated, a non-contact type temperature sensor is installed in the space to measure atmosphere temperature in the brake, i.e. braking frictional heat generated at a frictional interface between the brake lining and the brake drum, in real time, and a driver is visually or aurally informed of the measured atmosphere temperature in the brake such that the driver can more rapidly respond (take measures) thereto.

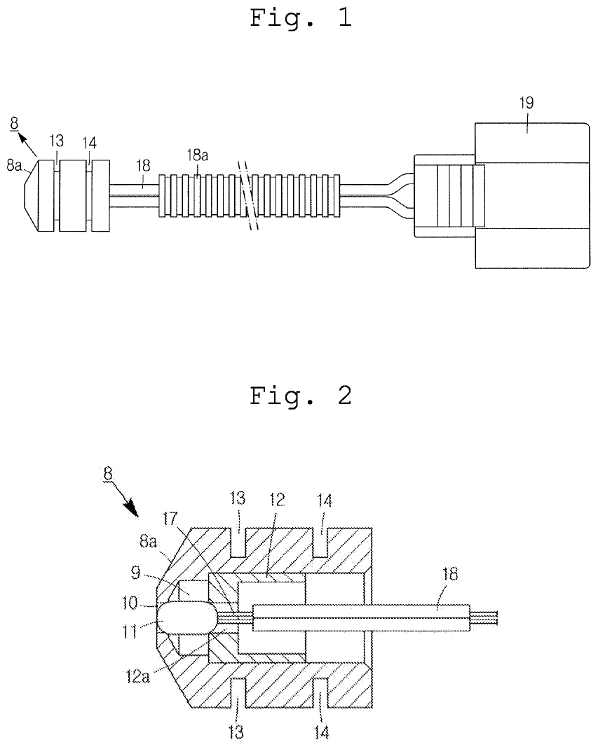

FIGS. 1 to 5 illustrate a device for sensing atmosphere temperature in a vehicle brake according to the present invention, wherein the device includes a space 5 formed in a brake lining 4 of a brake system installed at a wheel of a vehicle, e.g. a drum brake 2, the space 5 being configured to be open toward a drum 3, the space 5 being connected to a frictional surface 3a of the drum 3 such that aeration is performed therebetween, the space 5 having a predetermined inner diameter, a through-hole 7 formed through a brake shoe 6, the through-hole 7 being spatially connected to the space 5, the through-hole 7 having a predetermined inner diameter, a case 8 fitted into the through-hole 7 and fixed to the through-hole 7 by a fixing means, a part of the case 8 protruding into the space 5, an insertion recess 9 formed in the case 8, the insertion recess 9 being open to the rear, an aeration hole 10 formed in a front end of the case 8, the aeration hole 10 being configured to connect the space 5 and the insertion recess 9 such that aeration is performed therebetween, the aeration hole 10 having a predetermined inner diameter, a temperature sensor 11 installed in the insertion recess 9 by insertion, the temperature sensor 11 being exposed to the space 5 through the aeration hole 10, the temperature sensor 11 being configured to measure atmosphere temperature in the drum brake 2, e.g. the temperature of the frictional surface 3a of the drum 3 or the temperature of a frictional braking surface at which friction between the drum 3 and the brake lining 4 occurs, in real time in a non-contact manner, and a fixing member 12 installed at an inner circumferential surface of the insertion recess 9 by coupling, the fixing member 12 being configured to fix the temperature sensor 11, thereby preventing separation of the temperature sensor 11.

When an opening or a hole is formed in the brake shoe 6, the opening or the hole may be used as the space 5. When no hole is formed in the brake shoe 6, an opening having a predetermined inner diameter may be formed in the brake shoe 6 by boring so as to be used as the space 5.

Although it is preferable for the space 5 to be circular, the space 5 may be formed so as to have a polygonal shape, such as a quadrangle, a pentagon, a hexagon, or an octagon, an oval shape, or a combination thereof. Braking frictional heat (frictional braking heat) generated from the brake lining 4 and the drum 3 performing frictional braking in tight contact with each other by vehicle braking is completely transferred to the space 5, whereby atmosphere temperature in the drum brake 2 is transferred to the space 5. The temperature sensor 11, which has a short response time and excellent response characteristics, measures and outputs the atmosphere temperature in the drum brake 2 transferred through the aeration hole 10 in real time.

That is, the space 5 is connected to the frictional surface 3a of the drum 3 such that aeration is performed therebetween, braking frictional heat is generated from the frictional surface 3a of the drum 3 by direct friction during braking, and the temperature sensor 11 measures the temperature of the space 5 transferred through the aeration hole 10 in real time, whereby it is possible to rapidly and accurately measure the atmosphere temperature in the brake.

The inner diameter of the space 5 is slightly greater than the inner diameter of the through-hole 7, to which an outer circumferential surface of the case 8 is coupled, preferably 1.2 to 3 times the inner diameter of the through-hole 7, whereby it is possible for the temperature sensor 11 to rapidly and accurately measure braking frictional heat generated during braking.

If the inner diameter of the space 5 is less than 1.2 times the inner diameter of the through-hole 7, the atmosphere temperature in the brake or the temperature of the frictional surface 3a, which varies depending on braking force, is not immediately or rapidly transferred to the space 5. If the inner diameter of the space 5 is greater than 3 times the inner diameter of the through-hole 7, the frictional area of the brake lining 4 is reduced, whereby braking efficiency is lowered.

An element having resistance equally proportional to temperature change or a semiconductor element (an element having excellent temperature characteristics or an excellent temperature characteristic curve), such as a thermistor type temperature sensor or a resistance temperature detector (RTD) type temperature sensor, which has a short response time and excellent response characteristics, may be used as an example of the temperature sensor 11, whereby it is possible to rapidly and accurately measure atmosphere temperature (air temperature) in the brake transferred to the space 5 located in the brake.

The thermistor type temperature sensor is a semiconductor element having an electrical resistance value sensitively reduced with an increase in temperature. The thermistor type temperature sensor is manufactured by sintering a metal oxide, such as manganese oxide, nickel oxide, cobalt oxide, iron oxide, copper oxide, or titanium oxide. The thermistor type temperature sensor is structurally classified as a direct heat type temperature sensor, which directly applies heat using current, or a heat radiation type temperature sensor, which applies heat through a heater installed therearound. The thermistor type temperature sensor is used to measure or detect temperature. The measurement range of the thermistor type temperature sensor is about −50 to 300° C., and the sensitivity of the thermistor type temperature sensor is high.

The resistance temperature detector (RTD) type temperature sensor is a temperature sensor including a resistor, the resistance value of which is changed with a change in temperature. It is known that the resistance temperature detector (RTD) type temperature sensor is excellent in accuracy, repetitiveness, and stability.

FIG. 8 is a graph showing temperature characteristics of the temperature sensor 11 of the present invention and a surface temperature sensor for comparison therebetween. It can be seen therefrom that temperature signals measured by the surface temperature sensor are excessively bent, whereby characteristics of the temperature signals are non-linear, whereas characteristics of temperature signals measured by the temperature sensor 11 of the present invention are linear, whereby reliability in temperature measurement is high.

The temperature sensor 11 is installed in the space 5 so as to have a height less than the wear limit of the brake lining 4, whereby damage to or wear of the temperature sensor 11 is prevented even when the brake lining 4 is worn. When the brake lining 4 is replaced, therefore, the temperature sensor 11 may be separated from the brake lining 4 so as to be reused in a new brake system.

As the fixing means configured to allow the case 8 to be coupled and fixed to the through-hole 7 therethrough, the case 8 may be fitted into the through-hole 7 and may be fixed to the through-hole 7 using front-end and rear-end snap rings such that the case 8 cannot move, the case 8 may be fastened to the through-hole 7 through a male-female screw structure, or the case 8 may be fitted into the through-hole 7 and may then be fixed to the brake shoe 6 by welding.

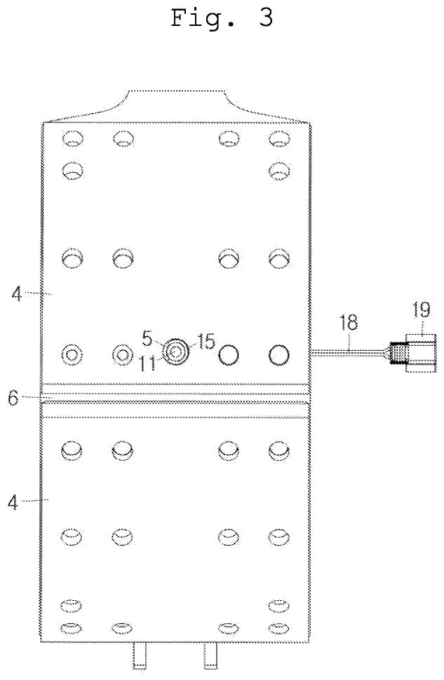

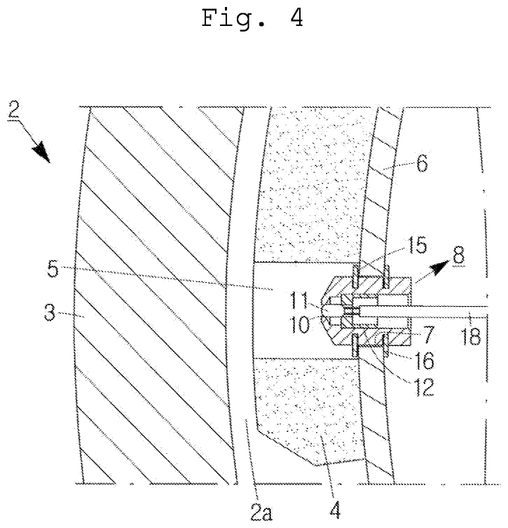

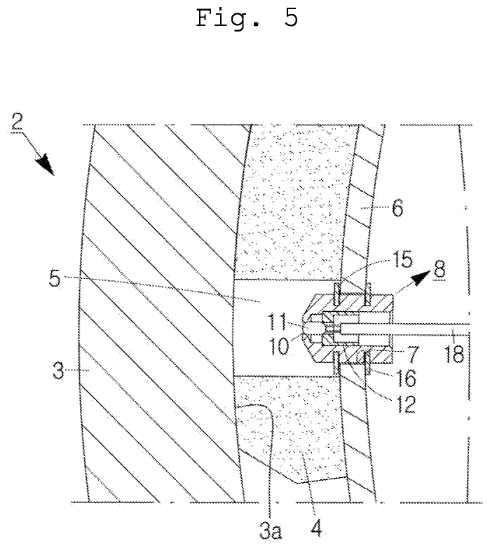

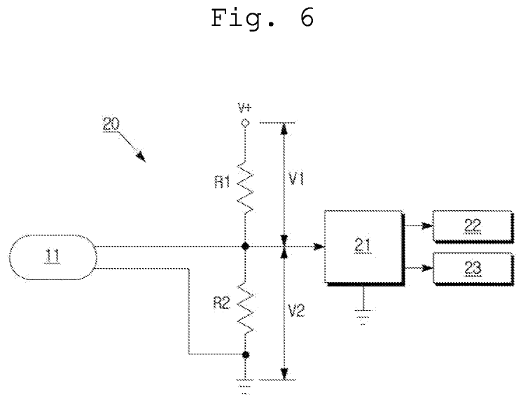

For example, when the snap rings are used as the fixing means, as shown in FIGS. 1 and 2, a front-end concave recess 13 and a rear-end concave recess 14 each having a predetermined depth are formed in front and rear ends of the outer circumferential surface of the case 8 so as to be spaced apart from each other by the thickness of the through-hole 7, and the case 8 is fitted into the through-hole 7 of the brake shoe 6. As shown in FIGS. 4 and 5, the front-end snap ring 15 is fitted into the front-end concave recess 13 so as to be coupled thereto, and the rear-end snap ring 16 is fitted into the rear-end concave recess 14 so as to be coupled thereto. As a result, the case 8 is securely supported and fixed in the state in which the brake shoe 6 is located between the front-end and rear-end snap rings 15 and 16.

The case 8 has an outer diameter sufficient to be fitted into the through-hole 7, and the front-end and rear-end concave recesses 13 and 14 spaced apart from each other by the thickness of the through-hole 7 are formed along the outer circumferential surface of the case 8 in the front and rear ends of the case 8. When the case 8 is coupled to the through-hole 7 by fitting, the front-end snap ring 15 is first fitted into the front-end concave recess 13 so as to be fixed thereto, the rear end of the case 8 is moved so as to protrude out of the through-hole 7, i.e. the brake shoe 6, and the rear-end snap ring 16 is fitted into the rear-end concave recess 14 protruding out of the brake shoe 6 so as to be coupled thereto. As a result, the front-end and rear-end snap rings 15 and 16 abut an inner surface and an outer surface of the brake shoe 6, respectively, whereby the case 8 is securely supported and fixed.

When the temperature sensor 11 is installed in the case 8 in advance, a lead 17 of the temperature sensor 11 or a cable 18 connected to the lead 17 is inserted into the through-hole 7 in advance so as to be withdrawn out of the brake shoe 6, the front-end snap ring 15 is fitted into the front-end concave recess 13 so as to be fixed thereto, the rear end of the case 8 is moved so as to protrude out of the through-hole 7, and the rear-end snap ring 16 is fitted into the rear-end concave recess 14 so as to be coupled thereto. As a result, the front-end and rear-end snap rings 15 and 16 abut the inner surface and the outer surface of the brake shoe 6, respectively, whereby the case 8 is securely fixed to the brake shoe 6. A connector 19 connected to the end of the cable 18 may be connected to a voltage conversion unit 20 through a corresponding connector (not shown) and may then be connected to a temperature monitoring device 21 or an MCU such that a temperature voltage signal is input.

The outer diameter of each of the front-end and rear-end snap rings 15 and 16 is greater than the inner diameter of the through-hole 7 and is less than the inner diameter of the space 5, whereby it is possible to easily and securely fix the case 8 to the brake shoe 6.

Each of the front-end and rear-end snap rings 15 and 16 may be a C ring or an E ring.

Since the case 8 is fixed by the front-end and rear-end snap rings 15 and 16, which are separably coupled to the front-end and rear-end concave recesses 13 and 14, respectively, the case 8 may be easily detachably attached to the brake shoe 6.

The case 8 may be made of a synthetic resin that is easily shapeable while exhibiting high heat resistance and low thermal conductivity, and may be configured to mainly measure the temperature of the space 5 transferred through the aeration hole 10.

An inclined surface 8a having a predetermined angle is formed at the front end of the case 8 so as to be inclined in a direction toward the front end thereof (a front direction) such that the case 8 can be easily coupled to the through-hole 7.

It is preferable for the fixing member 12, which fixes the temperature sensor 11 to the case 8, to be configured such that the temperature sensor 11 is forcibly coupled to an inner circumferential surface of the case 8, is adhered to the inner circumferential surface of the case 8 using an adhesive, is screw-engaged with the inner circumferential surface of the case 8, or is supported by a snap ring, whereby the temperature sensor 11 is not loosened or separated from the case 8 by vibration during driving of the vehicle.

A withdrawal hole 12a is formed in the front end of the fixing member 12 such that the lead 17 of the temperature sensor 11 is withdrawn to the rear end through the withdrawal hole 12a, and the cable 18, which is covered with a clothing material 18a, is connected to the end of the lead 17. The connector 19 is connected to the end of the cable 18.

FIG. 4 is a sectional view illustrating a non-braking state, wherein a gap 2a is maintained between the drum 3 and the brake lining 4, and FIG. 5 is a sectional view illustrating a braking state, wherein the drum brake 2 is extended by braking and comes into contact with the frictional surface 3a of the drum 3, whereby braking is achieved. Braking frictional force is transferred to the space 5 adjacent to the frictional surface 3a of the drum 3, and the temperature sensor 11 measures and outputs the temperature of the space 5 (atmosphere temperature in the brake) transferred through the aeration hole 10 in real time.

In the present invention, temperature measurement may be performed by directly measuring the resistance of the temperature sensor 11. In this case, however, the temperatures measured during driving may not be transmitted to a driver warning device. For this reason, voltage conversion may be performed using a voltage conversion unit 20 having simple construction, such as a voltage distribution circuit.

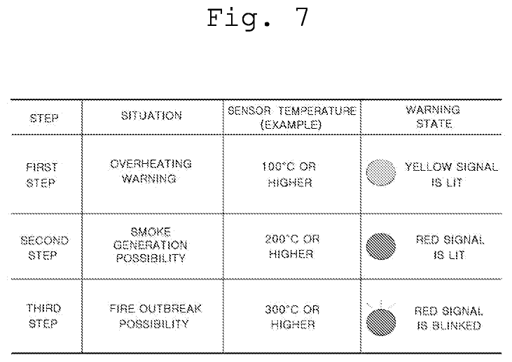

FIG. 6 is a view illustrating configuration of a circuit of the voltage conversion unit 20 shown as an example of the present invention, wherein both ends of a temperature sensor resistor R2 are connected to the end (cable or connector) of the lead 17 of the temperature sensor 11 such that temperature sensor voltage V2 is induced, and a distribution resistor R1, which is connected to a power supply V+, is connected to the other end of the temperature sensor resistor R2, one end of which is grounded, to output temperature voltage V₂.

The temperature voltage V₂ of the temperature sensor 11 may be obtained as represented by Equation (1) below.

$${V}_{2} = \frac{R 2}{R 1 + R 2} \times V + \qquad Equation ( 1 )$$

In Equation (1) above, V₂ indicates temperature voltage, V+indicates a power supply that applies positive (+) voltage to the voltage conversion unit 20, R1 indicates a distribution resistor or a pull-up resistor, and R2 indicates a resistor in the temperature sensor.

It is preferable for the power supply V to supply constant voltage, from which it is possible to obtain stable output voltage.

The voltage conversion unit 20 is connected to the temperature monitoring device 21, the electronic control unit (ECU), or control equipment in order to visually or aurally inform the driver of the atmosphere temperature in the brake measured by the temperature sensor 11.

The voltage conversion unit 20 may be mounted in the temperature monitoring device 21, and the temperature monitoring device 21 is configured to monitor brake temperature voltage input from the voltage conversion unit in real time.

In the present invention, the temperature monitoring device 21 may be connected to a display device 22 configured to visually inform the driver of brake abnormality or a warning device 23 or a warning system configured to aurally inform the driver of brake abnormality in a wired or wireless manner (hardwiring or Wi-Fi). When the atmosphere temperature in the brake reaches a specific value, the temperature monitoring device 21 outputs a display signal to the display device 22, which may be constituted by a screen (monitor), or outputs a warning sound to the warning device 23 based on internal logic thereof.

The warning device 23 or the warning system may emit a warning in any of various manners, such as tactile sense, in addition to auditory sense.

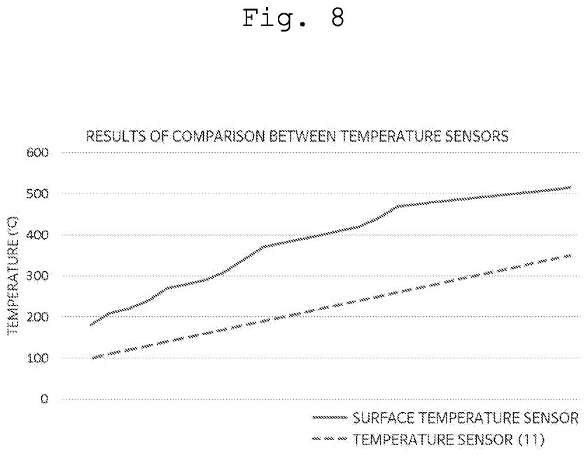

As shown in FIG. 7, the temperature monitoring device 21 of the present invention may configure a temperature map based on temperature signals input from the temperature sensor 11 and the voltage conversion unit 20 using control logic, and may visually and aurally inform the driver of brake abnormality through the display device 22 and/or the warning device 23.

For example, when the temperature measured by the temperature sensor 11 is 100° C. or higher, a determination may be made that the current state is a first step “overheating warning”, a yellow color display lamp may be lit and a warning sound having long cycles may be output while “overheating” sound (voice) is output. When the temperature measured by the temperature sensor 11 is 200° C. or higher, a determination may be made that the current state is a second step “smoke generation possibility”, a red color display lamp may be lit and a warning sound having normal cycles may be output while “smoke generation” sound (voice) is output. When the temperature measured by the temperature sensor 11 is 300° C. or higher, a determination may be made that the current state is a second step “fire outbreak possibility”, a red color display lamp may be blinked and a warning sound having short cycles or a “fire outbreak” sound (voice) may be output. Consequently, it is possible for the driver to recognize step-specific displays and warnings and to take measures thereto, and therefore it is possible to prevent overheating of the brake, fire outbreak of the brake, and shortening in lifespan of the brake. In addition, it is possible to prevent premature wear or deformation of brake parts, vehicle vibration, or vehicle noise.

In the present invention, the space connected to the braking frictional surface 3a such that aeration is performed therebetween is provided in the brake lining 4, and the temperature sensor 11 is installed in the space 5 in order to measure braking frictional heat generated during braking in a non-contact manner, whereby it is possible to rapidly and accurately determine the atmosphere temperature in the brake system and to display and warn abnormality of the brake system step by step, and therefore it is possible to prevent overheating of the brake, fire outbreak of the brake, and shortening in lifespan of the brake. In addition, it is possible to prevent occurrence of a safety-related accident of the vehicle.

In the present invention, the atmosphere temperature in the brake is measured using the temperature sensor 11, such as a thermistor type temperature sensor or an RTD type temperature sensor, in a non-contact manner, and the temperature sensor 11 is cooperatively connected to the temperature monitoring device 21, the display device 22, and the warning device 23, and visual and aural warning is provided to the driver for each specific temperature step such that the driver can rapidly respond (take measures) to the specific temperature step.

In the present invention, the atmosphere temperature in the braking device is measured using the thermistor type temperature sensor or the RTD type temperature sensor, whereby it is possible to provide a temperature sensing device having short response time, excellent temperature characteristics, and high reliability.

As is apparent from the above description, the present invention has an effect in that a space connected to a frictional braking surface in such a manner that aeration is performed therebetween is provided in a lining of a vehicle brake, and a temperature sensor is installed in the space to measure braking frictional heat (frictional braking heat) generated during braking in a non-contact manner, whereby it is possible to rapidly and accurately determine atmosphere temperature in a brake system, and therefore it is possible to prevent overheating of the brake, fire outbreak of the brake, and shortening in lifespan of the brake while preventing occurrence of a safety-related accident of a vehicle.

The present invention has an effect in that the atmosphere temperature in the brake system, i.e. the temperature of the frictional braking surface, is measured in real time particularly using a non-contact type temperature sensor installed at a large-sized vehicle, and visual and aural warnings are provided, whereby it is possible to rapidly respond to abnormality and take measures to address abnormality, and therefore it is possible to prevent overheating of the brake system, to increase braking efficiency, and to prevent premature wear or deformation of brake parts, vehicle vibration, or vehicle noise.

The temperature sensor of the present invention is installed in the space so as to have a height less than the wear limit of the brake lining, whereby damage to or wear of the temperature sensor is prevented even when the brake lining is worn. When the brake lining is replaced, therefore, the temperature sensor may be separated from the brake lining so as to be reused in a new brake system.

The temperature sensor of the present invention measures atmosphere temperature in a drum brake in real time in a non-contact manner, whereby characteristics of output temperature signals are linear, and therefore it is possible to obtain temperature signals suitable for various kinds of determination and control.

The present invention has an effect in that it is possible to conveniently obtain a temperature signal using a voltage conversion unit constituted by resistors without needing to amplify an output signal of the temperature sensor, whereby circuit configuration is simple and the present invention is insensitive to electrical noise.

The present invention has an effect in that the temperature sensor is cooperatively connected to a temperature monitoring device, a display device, and a warning device, and visual and aural warning is provided to a driver for each measured in-brake temperature step using a warning lamp and sound such that the driver can rapidly respond (take measures) thereto for each step. Consequently, the present invention is a very useful invention.

The present invention is not limited to the above embodiments and the accompanying drawings, and various substitutions, modifications, and alterations are possible without departing from the technical idea of the present invention, which is obvious to a person having ordinary skill in the art.

What is claimed is:

1. A device for sensing atmosphere temperature in a vehicle brake, the device comprising:
a brake installed at a vehicle;
a space formed in a brake lining, the space being open toward a drum, the space having a predetermined inner diameter;
a through-hole formed through a brake shoe, the through-hole having a predetermined inner diameter;
a case fitted in the through-hole, the case being fixed to the through-hole by a plurality of fixing means;
an insertion recess formed in the case, the insertion recess being formed so as to be open to a rear;
an aeration hole formed in a front end of the case, the aeration hole being configured to allow the space and the insertion recess to be connected to each other such that aeration is performed therebetween, the aeration hole having a predetermined inner diameter;
a temperature sensor fitted in the insertion recess, the temperature sensor being configured to measure frictional braking temperature transferred to the space; and
a fixing member configured to fix the temperature sensor.

2. The device according to claim 1, wherein the fixing means comprise:
a front-end concave recess and a rear-end concave recess formed along an outer circumferential surface of the case in front and rear ends of the case; and
a front-end snap ring and a rear-end snap ring coupled to the front-end concave recess and the rear-end concave recess, respectively, the front-end snap ring and the rear-end snap ring being supported by the brake shoe.

3. The device according to claim 1, wherein a shape of the space is a circle, a polygon, such as a quadrangle, a pentagon, a hexagon, or an octagon, an oval, or a combination thereof.

4. The device according to claim 1, wherein the temperature sensor is installed in the space so as to have a height less than a wear limit of the brake lining.

5. The device according to claim 1, further comprising:
a voltage conversion unit connected to the temperature sensor, wherein
the voltage conversion unit comprises:
a temperature sensor resistor having both ends connected to the temperature sensor; and
a distribution resistor connected to the other end of the temperature sensor resistor, the distribution resistor being connected to a power supply.

6. The device according to claim 5, further comprising:
a temperature monitoring device connected to the voltage conversion unit; and
a display device and a warning device connected to the temperature monitoring device.
